(19) United States
(12) Patent Application Publication
(10) Pub. No.: US 2026/0084531 A1
(43) Pub. Date: Mar. 26, 2026

(54) STEERING COLUMN SWITCH FOR A MOTOR VEHICLE, MOTOR VEHICLE, AND METHOD FOR SELECTING A FUNCTION BY MEANS OF A STEERING COLUMN SWITCH

(71) Applicant: VOLKSWAGEN AKTIENGESELLSCHAFT, Wolfsburg (DE)

(72) Inventors: Thomas Mauterer, Braunschweig (DE); Thomas Fricke, Danndorf (DE)

(21) Appl. No.: 19/112,551

(22) PCT Filed: Aug. 16, 2023
(86) PCT No.: PCT/EP2023/072589

§ 371 Date: Mar. 17, 2025

(30) Foreign Application Priority Data
Oct. 4, 2022 (DE) 10 2022 210 463.3

(51) Int. Cl. B60K 35/53; B60K 35/25; B60K 35/60

(52) U.S. Cl. CPC B60K 35/53; B60K 35/25; B60K 35/60; B60K 2360/685

(57) ABSTRACT

A steering column switch for a motor vehicle, such as an electric motor vehicle, facilitates function selection. The switch includes a rigid lever and a lever cap that at least partially surrounds the lever. The lever cap is mounted on the lever to tilt about at least two tilt axes, which are arranged orthogonally or substantially orthogonal to each other. At least one sensor is provided to detect the tilting of the lever cap and select a corresponding function. The present disclosure enables intuitive and adaptable function selection in motor vehicle steering systems.

The present application claims priority to International Patent Application No. PCT/EP2023/072589 to Mauterer et al., filed Aug. 16, 2023, which claims priority from German Patent App. No. DE 10 2022 210 463.3, filed Oct. 4, 2022, the contents of each being incorporated by reference in their entirety herein.

### TECHNICAL FIELD

The present disclosure relates to a steering column switch, to a steering wheel system, to a motor vehicle, and to a related method for operating the same.

### BACKGROUND

Steering concepts and their designs are evolving in modern motor vehicles. For example, steering systems and associated steering wheels are increasingly integrated into electrical control systems. As a result, the position and the design of both the steering system and of the steering wheels can change. Nonetheless, the customary selection concepts are to be available to the driver or operators expect access to familiar selection options. Consequently, adapting the steering column levers to accommodate functions such as directional signaling, windshield wiper system, and various other functions to the new circumstances.

Currently, steering column switches with a rigid base body are known in the art. The base body, affixed near the steering column, incorporates the necessary sensor system for function selection. A handle body, attached to the base body, enables the operator to choose functions, while simultaneously covering and protecting, the sensor system. To activate these functions, the handle body must be rotated about the axis of the base body or displaced axially along that axis. To operate this steering column switch, the operator typically must release the steering wheel and, in some cases, divert their attention to ensure accurate function selection.

### SUMMARY

Aspects of the present disclosure are directed to at least partially overcome at least one of the above-described disadvantages of the steering system of a motor vehicle. In particular, some aspects of the present disclosure provide a steering column switch for a motor vehicle, a motor vehicle, and a method for selecting a function by means of a steering column switch for a motor vehicle, which allow functions to be easily selected in a motor vehicle.

According to some aspects of the present disclosure, the described functionality is achieved by the independent claims of the present application, as detailed below. Additional aspects are disclosed in the dependent claims, the description, and the drawings. Features and details that are described in connection with the steering column switch according to the present disclosure also apply in connection with the motor vehicle, and/or in connection with the method, and conversely, so that mutual reference is made, or can be made, in each case to the individual aspects with respect to the disclosure.

In some examples,, a steering column switch is disclosed for a motor vehicle, e.g., an electric motor vehicle, for selecting functions, comprising a rigid lever and a lever cap that at least partly surrounds the lever, wherein the lever cap is mounted on the lever so as to be tiltable about at least two tilt axes that are arranged orthogonally or substantially orthogonally with respect to one another, wherein at least one sensor is provided, which is designed to select a function as a result of a tilting of the lever cap.

In some examples, a steering wheel system is disclosed, comprising a steering wheel, a steering wheel mount, and at least one above-described steering column switch, wherein the lever of the at least one steering column switch is attached to the steering wheel or to the steering wheel mount.

Such a steering wheel system may be advantageously used in steer-by-wire steering systems. The steering wheel system can be flexibly adapted to the design requirements and the needs of the operator.

In some examples, a motor vehicle is disclosed, comprising a steering column switch configured according to the present disclosure. The functions disclosed herein advantageously result for the motor vehicle.

In some examples, a method is disclosed for selecting a function by means of a steering column switch in a motor vehicle, comprising: tilting the steering column switch via at least one tilt axis; detecting the position of the steering column switch by the control unit polling the at least one sensor; selecting the function based on the detected position by the control unit; and relaying the selected function by the control unit via an interface to the motor vehicle controller for carrying out an action corresponding to the selected function.

The position that is detected is previously set by the operator based on the desired function by means of a tilt process.

Additional advantages, features and details of the present disclosure will be apparent from the following description, which describes in detail multiple exemplary embodiments of the invention with reference to the drawings. The features described in the claims and in the description can be an aspect of the present disclosure either alone or in any arbitrary combination.

### BRIEF DESCRIPTION OF THE DRAWINGS

Certain aspects of the present disclosure are illustrated in the following figures:

FIG. 1 shows a schematic representation of a steering column switch comprising a push button, according to some aspects of the present disclosure;

FIG. 2 shows a schematic representation of a steering column switch comprising a push button and a Hall sensor, according to some aspects of the present disclosure;

FIG. 3 shows a schematic representation of a steering column switch comprising a push button having a tilted lever cap, according to some aspects of the present disclosure;

FIG. 4 shows a schematic representation of a steering column switch having a flexible and yielding lever cap, according to some aspects of the present disclosure;

FIG. 5 shows a schematic representation of a steering wheel system, according to some aspects of the present disclosure;

FIG. 6 shows a schematic representation of a motor vehicle comprising a steering wheel system according to FIG. 5, according to some aspects of the present disclosure; and

FIG. 7 shows a method for selecting a function by means of a steering column switch according to any one of FIGS. 1 to 4, according to some aspects of the present disclosure.

### DETAILED DESCRIPTION

As used herein, “tilt axes” refers to a first tilt axis and a second tilt axis, neither of which aligns with the longitudinal axis of the lever. Both the first tilt axis and the second tilt axis are orthogonal or substantially orthogonal to the longitudinal axis of the lever. Accordingly, the first tilt axis may correspond to the vertical axis of the lever, while the second tilt axis may correspond to the transverse axis of the lever.

A “function” as used herein denotes the selection of directional signaling, such as blinking right or blinking left, or the selection of the windshield wiper. This list serves as an example and is not intended to be exhaustive.

In some examples, the tilting movement of the handle cap about the vertical axis, the transverse axis, or both enables the operator to select the desired function without releasing the steering wheel. This operation is straightforward and enhances driving safety, as it does not require the operator to divert their attention. Additionally, this design replicates the tactile feel of traditional mechanical steering column levers, which feature a lower center of rotation and are mounted to the steering column, facilitating intuitive use by the operator.

The present disclosure allows for the possibility of superimposing movements along the tilt axes. This capability enables the storage of additional functions, varying intensity levels of individual functions, or the simultaneous selection of multiple functions.

The steering column switch described herein can be readily adapted to different motor vehicle configurations, as its operating zone is confined to the lever cap region. As a result, the lever's length can be flexibly adjusted to suit specific needs.

Within the scope of the present disclosure, the at least one sensor may advantageously comprise one push button per tilt axis. This push button could incorporate an integrated spring, a rubber mat, or both. The push button generates a pulse or signal to activate a circuit or process, triggered solely by pressure and based on line resistance. The selected function depends on the lever cap's position relative to the lever and the function assigned to that position. Assigning a dedicated push button to each function enhances the precision of function selection.

The present disclosure also contemplates the use of a Hall sensor, particularly a 3D Hall sensor, as the at least one sensor. This Hall sensor produces a pulse or signal to initiate a circuit or process. The function selected corresponds to the lever cap's position relative to the lever, which the Hall sensor detects and signals accordingly.

When multiple sensors are employed in the steering column switch, a combination of push buttons and Hall sensors may be used. This arrangement expands the range of storable functions and supports the superimposition of movements along the tilt axes.

The lever cap may be configured to perform the tilting movement through a spring mount between the lever cap and the lever, through the material properties of the lever cap, or both. Implementing the tilting movement via a spring mount or the lever cap's material is straightforward and requires minimal components, reducing manufacturing costs. When a spring mount generates the tilting movement, the lever cap is preferably made of a hard plastic material. Conversely, when the tilting movement relies on the material, a flexible and resilient plastic, such as silicone, is advantageous for the lever cap.

The at least one sensor may include a detent cam to control the intensity of the selected function. This detent cam allows the intensity to be adjusted. For instance, with directional signaling (commonly known as “blinking”), a first intensity might indicate a lane change, with a short duration such as four blinks, while a second intensity might indicate a turning process, designed for a longer duration. Similarly, for the windshield wiper function, the detent cam can adjust the wiper blade speed between a first and second intensity. Each detent point on the cam may offer distinct resistance, providing haptic feedback to the operator about which detent point has been reached. This resistance could be achieved mechanically, with catch lugs moving into detent openings of varying depths, potentially using a double-stroke mechanism. The operator perceives the intensity through the differing depths of the detent openings overcome during movement. Alternatively, resistance could be set electronically, with haptic feedback-such as vibrations from a motor-indicating the selected detent point. In either case, the operator's applied force determines the intensity, whether mechanically or electronically implemented.

In some examples, a restoring function may be provided to return the lever cap to a neutral position, executed either mechanically or electronically. This restoration could utilize a spring, a magnet, or both, which is particularly useful for functions with a predetermined end or termination. The function's duration or a specific termination action can be predefined. The duration might be controlled by the spring or magnet's force, or a signal could release the spring or activate the magnetic force. The restoration method may vary depending on the function or its selected intensity. For example, with a short first-intensity directional signal, a spring might restore the lever cap after a set time, limiting blinking to four instances. For a second-intensity signal, termination might depend on a steering angle sensor's signal, comparing values until the criteria for ending the signal are met, though the operator retains the option to terminate it manually. This steering-angle-based disengagement is energy-efficient, requiring power only for the termination process.

The present disclosure may optionally include a control unit with a data-communicating connection to the sensor. This control unit is configured to detect the lever cap's position by polling the sensor, select at least one function based on that position, and transmit the selected function to a motor vehicle controller via an interface for execution. The control unit streamlines the process by relaying the selected function to the vehicle controller, which activates the appropriate functional units. Data regarding the function's intensity or restoring function can be stored in the control unit. Additionally, the control unit may detect the steering column switch's position by polling a push button with an integrated spring or rubber mat, a Hall sensor, or a 3D Hall sensor. When polling a push button, the control unit identifies the activated button and determines the corresponding position and function. With a Hall sensor, especially a 3D variant, the control unit recognizes the lever cap's position and the operator-selected function.

In some examples, the steering column switch may be tilted along a detent cam, which specifies the intensity of the selected function. As previously described, this detent cam adjusts the function's intensity. For directional signaling, a first intensity might trigger a brief lane-change signal, such as four blinks, while a second intensity sustains a longer turning signal. For windshield wipers, the first and second intensities could set different wiper speeds. Each detent point may provide unique resistance for haptic feedback, achieved mechanically with catch lugs and variably deep detent openings via a double-stroke mechanism, or electronically with vibration feedback from a motor. The operator's force determines the intensity in both mechanical and electronic solutions.

In some examples, the steering column switch may be restored to a neutral position after function execution using a restoring function, implemented mechanically or electronically. A spring or magnet can facilitate this restoration, ideal for functions with a set termination. The duration or termination action can be predefined, with the spring or magnet's force establishing the duration, or a signal triggering the restoration. The restoration type may depend on the function or intensity. For instance, a short first-intensity directional signal might use a spring for a four-blink duration, while a second-intensity signal might end based on steering angle sensor data, with manual termination still available.

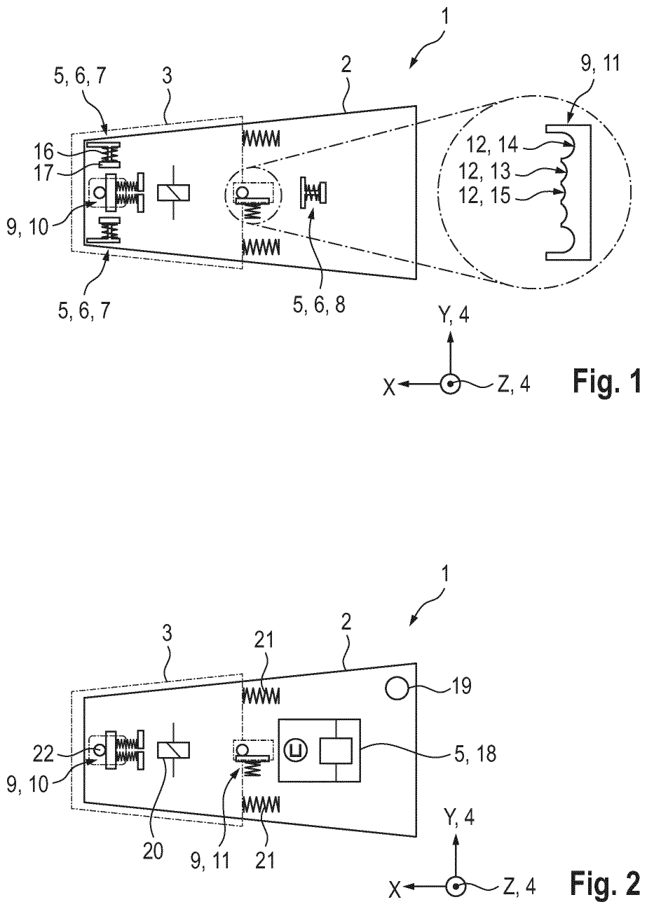

FIGS. 1 to 4 each show a steering column switch 1 for a motor vehicle, in particular an electric motor vehicle, for selecting functions such as the windshield wiper system or the turn signal. The steering column switch 1 comprises a rigid lever 2 and a lever cap 3 that at least partly surrounds the lever 2. The lever cap 3 is mounted on the lever 2 so as to be tiltable about at least two tilt axes 4 that are arranged orthogonally or substantially orthogonally with respect to one another. In addition, at least one sensor 5 is provided, which is designed to select a function as a result of tilting the lever cap 3.

The tilt axes 4 are the vertical axis Y and the transverse axis Z, both of which are orthogonal or at least substantially orthogonal with respect to the longitudinal axis X of the lever 2.

The steering column switch 1 according to FIG. 1 comprises three sensors 5 in the form of push buttons 6. Two of the push buttons 6 can be tilted about the transverse axis Z, while one push button 6 can be tilted about the vertical axis Y. A first detent cam 10 is assigned to the two transverse axis push buttons 7, and a second detent cam 11 is assigned to the vertical axis push button 8. By means of the first detent cam 10 and the second detent cam 11, the operator can set a first intensity and a second intensity via the detent points 12. In this process, the lever cap 3 is displaced from the neutral position 15 into a first stage 13 for the first intensity or a second stage 14 for the second intensity. A special feature of the first detent cam 10 from FIG. 1 is that it is assigned to two push buttons 6; each of the two push buttons 6 has dedicated detent points 12 along the detent cam 9. The two transverse axis push buttons 7 are used, for example, to signal direction, with one of the push buttons 6 being responsible for “right” and the other push button 6 being responsible for “left,” and each of the push buttons can be displaced from a neutral position 15 into a first and a second stage 14.

So as to better set the function and improve the haptics during the setting process, an integrated spring 16 and a rubber mat 17 are provided for the push buttons 6, for both the transverse axis push buttons 7 and the vertical axis push button 8.

The steering column switch 1 according to FIG. 2 comprises a Hall sensor 18, which serves as the sensor 5 to determine the position of the lever cap 3 through the control unit 19, allowing the selected function to be relayed by the control unit 19 that has a data-communicating connection to the sensor. The control unit 19 is configured to detect the position of the lever cap 3 by polling the at least one sensor, to select at least one function based on the detected position of the lever cap, and to relay the selected function for carrying out an action corresponding to the selected function to a motor vehicle controller via an interface.

Detent cams 9 are also provided here. The first detent cam 10 is designated for the function that carries out the tilting movement via the transverse axis Z, and the second detent cam 11 is designated for the function that carries out the tilting movement via the vertical axis Y.

An electromagnet 20 is included in both the exemplary embodiment according to FIG. 1 and the exemplary embodiment according to FIG. 2 to hold the steering column switch 1 in the desired function or to return the steering column switch 1 to its neutral position 15. The tilting of the lever cap 3 about the transverse axis Z and/or the vertical axis Y is achieved via a spring mount 21.

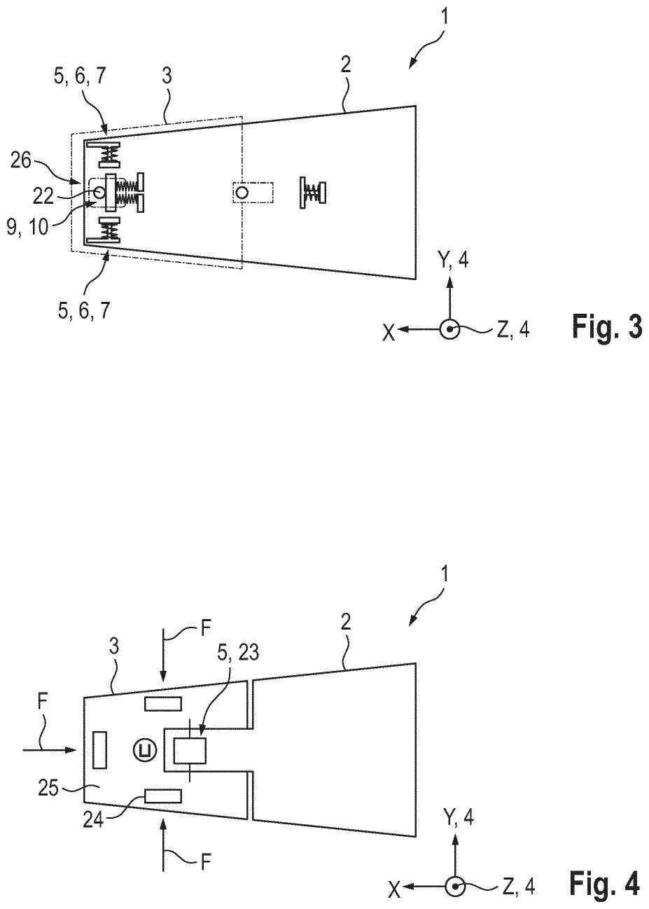

FIG. 3 shows a steering column switch 1 comprising a lever cap 3 that is tilted about the transverse axis Z. It is apparent that a catch lug 22 of the detent mechanism 26 is engaged in a detent point of the detent cam 9. Here, only a two-stage detent cam is shown in a simplified illustration.

FIG. 4 shows a steering column switch 1 that generates the tilting movement through the material of the lever cap 3, specifically silicone in this example. The switch includes a 3D Hall sensor 23 to cover all directions of movement. The detection and assignment of the position-dependent function are carried out and relayed via the control unit 19.

The intensity is set based on the pressure or force that the operator applies to the lever cap 3 during the tilting movement for selecting the function. Additionally, pressure pick-ups 24 can be provided for this purpose. Furthermore, a vibration motor 25 is included, allowing the selected intensity to be communicated back to the operator through vibration.

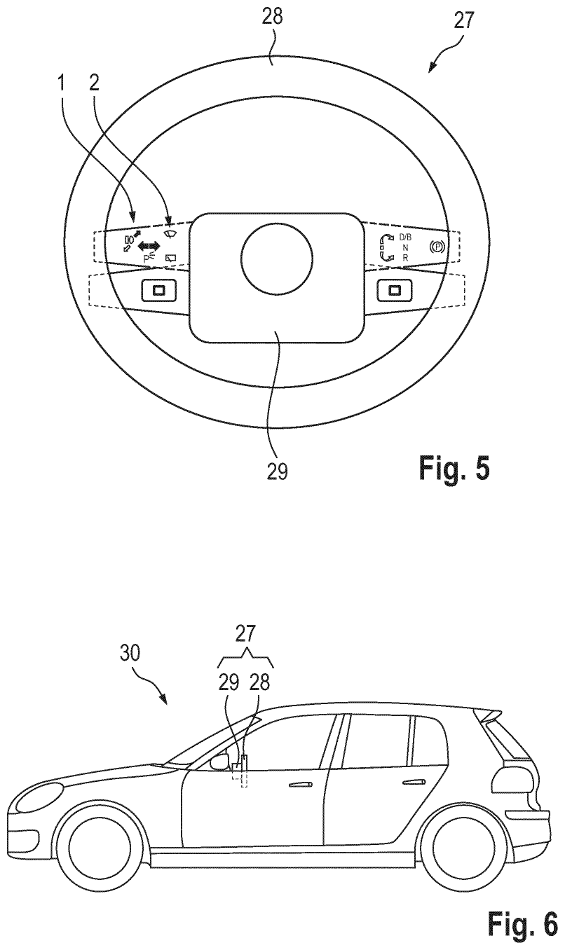

FIG. 5 schematically shows a steering wheel system 27 comprising a steering wheel 28, a steering wheel mount 29, and at least one of the above-described steering column switches 1. The lever 2 of the steering column switch 1 is attached to either the steering wheel 28 or the steering wheel mount 29.

FIG. 6 schematically shows a motor vehicle 30, specifically an electric motor vehicle 30, comprising a steering wheel system 27 according to FIG. 5 and at least the steering column switch 1 according to FIGS. 1 to 4.

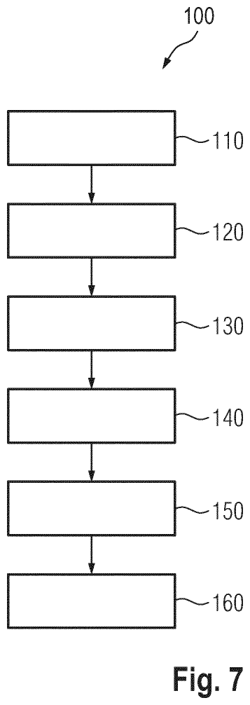

FIG. 7 shows the method 100 for selecting a function using the steering column switch 1 according to any one of FIGS. 1 to 4 in a motor vehicle, comprising the following steps: tilting 110 the steering column switch 1 via at least one tilt axis; detecting 120 the position of the steering column switch 1 by the control unit 19 polling the at least one sensor 5; selecting 130 the function based on the detected position by the control unit 19; and relaying 140 the selected function by the control unit 19 via an interface to the motor vehicle controller to carry out an action corresponding to the selected function.

The control unit 19 detects the position of the steering column switch 1 by means of the push buttons 6, which include an integrated spring 16 and/or rubber mat 17, or by means of the Hall sensor 18 or the 3D Hall sensor 23.

Furthermore, the steering column switch 1 is tilted along a detent cam 9 about the transverse axis Z or the vertical axis Y, with the detent cam 9 specifying the intensity of the selected function.

After the function has been carried out 150, the steering column switch 1 is returned 160 to a neutral position 15 via a spring or electronically.

### LIST OF REFERENCE NUMERALS

1 steering column switch
2 lever
3 lever cap
4 tilt axes
5 sensor
6 push button
7 transverse axis push buttons
8 vertical axis push button
9 detent cam
10 first detent cam
11 second detent cam
12 detent points
13 first stage
14 second stage
15 neutral position
16 integrated spring
17 rubber mat
18 Hall sensor
19 control unit
20 electromagnet
21 spring mount
22 catch lug
23 3D Hall sensor
24 pressure pick-up
25 vibration motor
26 detent mechanism
27 steering wheel system
28 steering wheel
29 steering wheel mount
30 motor vehicle
100 method
110 tilting
120 detecting

1-13. (canceled)

14. A steering column switch for a motor vehicle, comprising:
a rigid lever;
a lever cap that at least partially surrounds the rigid lever, wherein the lever cap is mounted on the rigid lever to tilt about at least two tilt axes arranged orthogonally or substantially orthogonally to each other; and
at least one sensor configured to select a function based on tilting of the lever cap.

15. The steering column switch of claim 14, wherein the at least one sensor comprises at least one push button associated with each tilt axis of the at least two tilt axes.

16. The steering column switch of claim 14, wherein the at least one sensor comprises at least one Hall sensor.

17. The steering column switch of claim 14, wherein the lever cap is configured to tilt about the at least two tilt axes via a spring mount positioned between the lever cap and the rigid lever or based on material properties of the lever cap.

18. The steering column switch of claim 14, wherein the at least one sensor comprises a detent cam configured to adjust an intensity of the selected function.

19. The steering column switch of claim 14, further comprising a restoring mechanism configured to return the lever cap to a neutral position mechanically or electronically after the function is selected.

20. The steering column switch of claim 14, further comprising a control unit in data-communication with the at least one sensor, wherein the control unit is configured to detect a position of the lever cap by polling the at least one sensor, select the function based on the detected position of the lever cap, and transmit the selected function to a motor vehicle controller via an interface to execute an action corresponding to the selected function.

21. A steering wheel system for a motor vehicle, comprising:
a steering wheel;
a steering wheel mount; and
a steering column switch including:
a rigid lever attached to the steering wheel or the steering wheel mount;
a lever cap that at least partially surrounds the rigid lever, wherein the lever cap is mounted on the rigid lever to tilt about at least two tilt axes arranged orthogonally or substantially orthogonally to each other; and
at least one sensor configured to select a function based on tilting of the lever cap.

22. The steering wheel system of claim 21, wherein the at least one sensor of the steering column switch comprises at least one push button associated with each tilt axis of the at least two tilt axes.

23. The steering wheel system of claim 21, wherein the at least one sensor of the steering column switch comprises at least one Hall sensor.

24. The steering wheel system of claim 21, wherein the lever cap of the steering column switch is configured to tilt about the at least two tilt axes via a spring mount positioned between the lever cap and the rigid lever or based on material properties of the lever cap.

25. The steering wheel system of claim 21, wherein the at least one sensor of the steering column switch comprises a detent cam configured to adjust an intensity of the selected function.

26. The steering wheel system of claim 21, wherein the steering column switch further comprises a restoring mechanism configured to return the lever cap to a neutral position mechanically or electronically after the function is selected.

27. The steering wheel system of claim 21, wherein the steering column switch further comprises a control unit in data-communication with the at least one sensor, wherein the control unit is configured to detect a position of the lever cap by polling the at least one sensor, select the function based on the detected position of the lever cap, and transmit the selected function to a motor vehicle controller via an interface to execute an action corresponding to the selected function.

28. A method for selecting a function using a steering column switch in a motor vehicle, wherein the steering column switch comprises a rigid lever, a lever cap that at least partially surrounds the rigid lever and is mounted to tilt about at least two tilt axes arranged orthogonally or substantially orthogonally to each other, and at least one sensor, the method comprising:
tilting the lever cap about at least one tilt axis of the at least two tilt axes;
detecting a position of the lever cap by polling the at least one sensor with a control unit;
selecting the function with the control unit based on the detected position of the lever cap; and
transmitting the selected function from the control unit via an interface to a motor vehicle controller to execute an action corresponding to the selected function.

29. The method of claim 28, wherein the at least one sensor comprises at least one push button associated with each tilt axis of the at least two tilt axes, and detecting the position of the lever cap comprises polling the at least one push button with the control unit.

30. The method of claim 28, wherein the at least one sensor comprises at least one Hall sensor, and detecting the position of the lever cap comprises polling the at least one Hall sensor with the control unit.

31. The method of claim 28, wherein the lever cap is configured to tilt about the at least two tilt axes via a spring mount positioned between the lever cap and the rigid lever or based on material properties of the lever cap, and tilting the lever cap comprises applying a force to the lever cap to engage the spring mount or deform the material properties.

32. The method of claim 28, wherein the at least one sensor comprises a detent cam configured to adjust an intensity of the selected function, and tilting the lever cap comprises moving the lever cap along the detent cam to set the intensity of the selected function.

33. The method of claim 28, wherein the steering column switch further comprises a restoring mechanism, and the method further comprises restoring the lever cap to a neutral position mechanically or electronically with the restoring mechanism after executing the action corresponding to the selected function.
